(19) United States
(12) Patent Application Publication
(10) Pub. No.: US 2007/0138068 A1
(43) Pub. Date: Jun. 21, 2007

(54) Hinged disc for disc screen

(76) Inventor: Robert M. Davis, Jamul, CA (US)

Correspondence Address: MICHAEL H JESTER, 505 D GRAND CARIBE CAUSEWAY, CORONADO, CA, 92118, US

(21) Appl. No.: 11/305,653

(22) Filed: Dec. 18, 2005

(51) Int. Cl. B07B 13/00; B07C 5/12

(52) U.S. Cl. 209/672

(57) ABSTRACT

A disc for releasable attachment to a shaft of a disc screen apparatus includes a generally ring-shaped hub. The hub has a bore and a split defining a pair of opposing ends. The hub also has a hinge intermediate the opposing ends that permits the opposing ends of the hub to be separated a predetermined distance sufficient to allow the shaft of the disc screen apparatus to pass between the opposing ends into the bore. A plurality of outer impacting elements are supported on the hub and are configured for engaging materials to be classified and propelling the materials in a conveying direction when the hub is rotated. A mechanism is provided to secure the hub to the shaft so that the shaft extends through the bore.

### FIELD OF THE INVENTION

The present invention relates to machines used to separate particulate materials or mixed recyclable materials into difference fractions, and more particularly, to a disc construction for a disc screen that allows its discs to be more easily removed and replaced.

### BACKGROUND OF THE INVENTION

Disc screens have long been used to separate particulate materials such as wood chips into difference fractions, according to size. More recently disc screens have been used to separate or classify mixed recyclable materials into respective streams of similar materials such as broken glass, containers, mixed paper and newspaper.

A disc screen typically includes a frame in which a plurality of rotatable shafts are mounted in parallel relationship. A plurality of discs are mounted on each shaft and a chain drive rotates the shafts in the same direction. The discs on one shaft interleave with the discs on each adjacent shaft to form screen openings between the peripheral edges of the discs. The size of the openings determines the dimension (and thus the type) of material that will fall through the screen. Rotation of the discs, which have an irregular outer contour, agitates the mixed recyclable materials to enhance classification. The rotating discs also propel the larger articles which are too big to fall between the discs across the screen. The general flow direction extends from an input area where the stream of material pours onto the disc screen to an output where the larger articles pour off of the disc screen. The smaller articles fall between the discs onto another disc screen or a conveyor, or into a collection bin.

The discs of a disc screen normally have a central opening or bore that allows them to be slid over the end of a shaft which may have a round or square cross-section. See for example U.S. Pat. No. 4,836,388 of Bielagus granted Jun. 6, 1989. Over time, the discs wear out and must be replaced. It is not practical to re-surface or repair damaged or worn discs without removing them from the shafts of the disc screen. However, it is tedious to dismount the ends of the shafts of a disc screen from their respective bearings so that the old discs can be removed and replaced by sliding the discs off the ends of the shafts. Moreover, if only singe disc is worn out or broken, it is usually necessary to remove several discs before the damaged or broken disc can be slid off the shaft. In order to alleviate these problems, a split disc was developed by CP Manufacturing, Inc. of National City, California. See U.S. Pat. No. 6,318,560 of Robert M. Davis granted Nov. 20, 2001. The split disc is comprised of two identical halves which are assembled around a shaft and tightly held together by a pair of bolt assemblies which clamp the disc to the shaft. Each disc half is made of an outer rubber portion which is stiffened with a rigid internal metal frame embedded inside the rubber portion. While the aforementioned patented two-piece disc construction has been commercially successful, it would be desirable to provide a disc construction that is even more convenient to remove and install.

### SUMMARY OF THE INVENTION

In accordance with an embodiment of the present invention, a disc for releasable attachment to a shaft of a disc screen apparatus includes a generally ring-shaped hub. The hub has a bore and a split defining a pair of opposing ends. The hub also has a hinge intermediate the opposing ends that permits the opposing ends of the hub to be separated a predetermined distance sufficient to allow the shaft of the disc screen apparatus to pass between the opposing ends into the bore. A plurality of outer impacting elements are supported on the hub and are configured for engaging materials to be classified and propelling the materials in a conveying direction when the hub is rotated. A mechanism is provided to secure the hub to the shaft so that the shaft extends through the bore.

### BRIEF DESCRIPTION OF THE DRAWINGS

FIG. 1 is an exploded perspective view of a shaft of a disc screen with a pair of hinged discs, one being mounted on the shaft and another one in position for mounting.

FIG. 2 is a side elevation view, with portions broken away, of one of the hinged discs of FIG. 1.

FIG. 3 is an end elevation view of the hinged disc of FIG. 2 taken from the left side of FIG. 2 and illustrating details of embedded structures in phantom lines.

FIG. 4 is a cross-sectional view of the hinged disc of FIG. 2 taken along line 4-4 of FIG. 2.

FIG. 5 is a perspective view of one of the metal inserts of the hinged disc of FIG. 2.

FIG. 6 is a side elevation view of a hinged metal insert of an alternate embodiment of the present invention.

FIG. 7 is an end elevation view of the hinged metal insert of FIG. 6.

### DETAILED DESCRIPTION

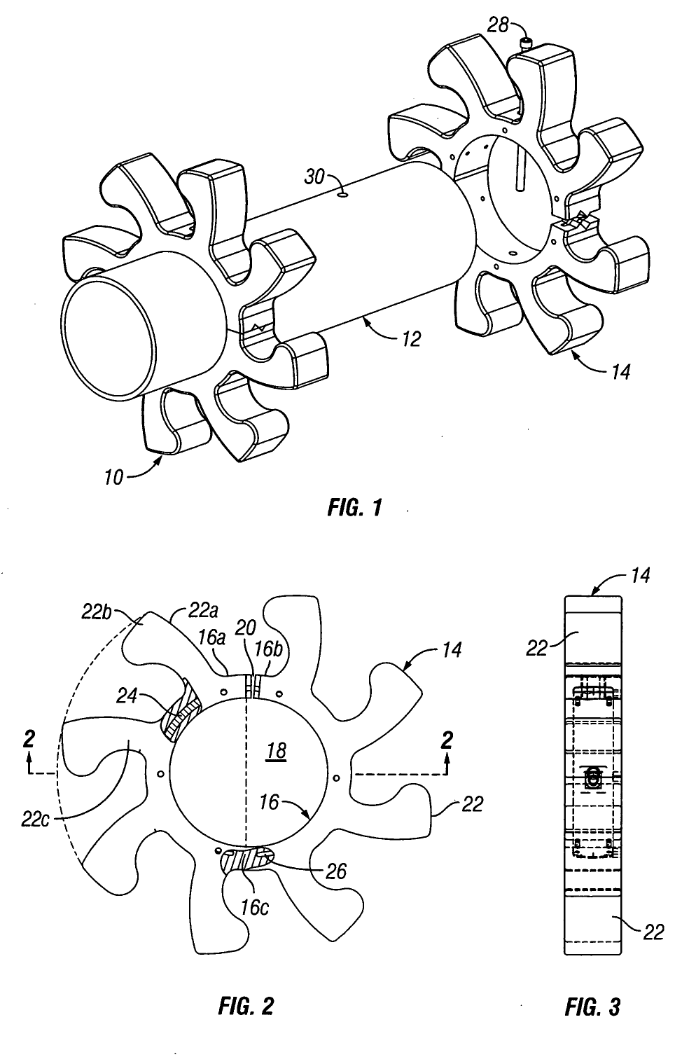

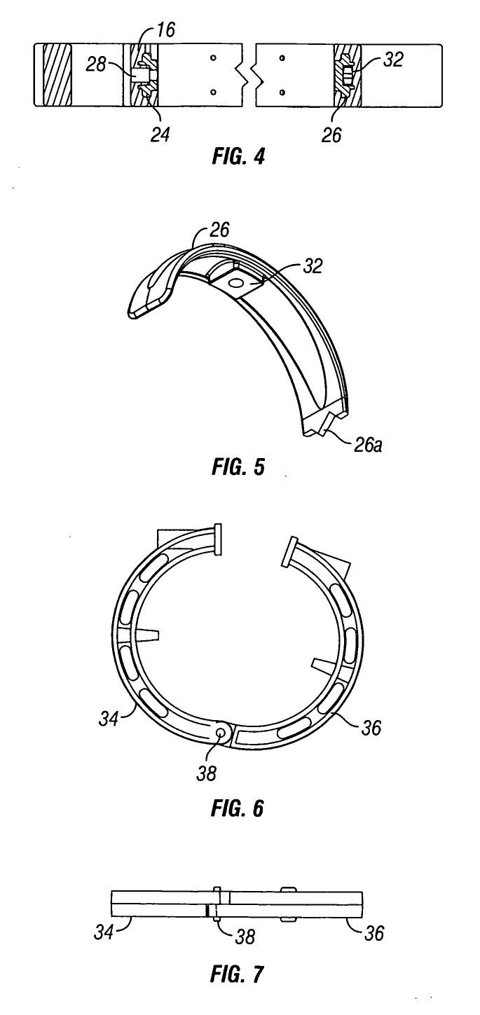

Referring to FIG. 1, a first hinged disc 10 is mounted on a hollow round shaft 12 and a second identical hinged disc 14 is in position for mounting on the shaft 12. Only a portion of the shaft 12 is illustrated in FIG. 1. The shaft would typically be long enough to support a dozen or more discs in spaced apart fashion. The ends of the shaft 12 are supported by bearing assemblies (not illustrated) of a disc screen (not illustrated) such as those disclosed in U.S. Pat. No. 6,250,478 of Robert M. Davis granted Jun. 26, 2001 and U.S. Pat. No. 6,648,145 of Robert M. Davis et al. granted Nov. 18, 2003, and co-pending U.S. patent application Ser. No. 10/044,222 of Robert M. Davis filed Nov. 21, 2005, the entire disclosures of which are incorporated herein by reference.

Referring to FIG. 2, each hinged disc, such as the hinged disc 14, is specially configured for use in classifying mixed recyclable materials. The hinged disc 4 includes a generally ring-shaped 5 hub 16 formed of an elastomeric material, i.e. a rubber-like synthetic polymer such as silicone rubber or polyurethane. The hub has a bore 18 and a split 20 defining a pair of opposing ends 16a and 16b. The hub 16 also has a hinge segment 16c intermediate the opposing ends 16a and 16b that permits them to be manually separated a sufficient to distance to allow the shaft 12 to pass between the opposing ends 16a and 16b into the bore 18. A plurality of outer impacting elements 22 in the form of radially extending arms are supported on the hub 16 and are configured for engaging materials to be classified (not illustrated) and propelling the materials in a conveying direction when the hub is rotated. The hinged disc 14 is designed to be rotated clock-wise in FIG. 2 for propelling materials to the right. The impacting elements 22 are also made of elastomeric material and are integrally formed with the hub 16.

The hub segment 16c has sufficient flexibility to allow the opposing ends 16a and 16b to be manually separated for mounting the hinged disc 14 on the shaft 12. A pair of identical rigid inserts 24 and 26 are embedded in the hub 16 on opposite sides of the hinge segment 16c. The inserts 24 and 26 are preferably made of metal, such as cast Aluminum. The lightweight metal inserts 24 and 26 provide additional strength and rigidity to accommodate means for securing the hub 16 to the shaft 12 so that the shaft 12 extends through the bore 18. The opposing ends 16a and 16b of the hub 16 and the inserts 24 and 26 have complementary mating shapes to aid in aligning these opposing ends when the hub 16 is secured to the shaft 12. More particularly, the mating shapes have a saw-tooth configuration such as 26a as best seen in FIG. 5.

In the form illustrated, the means for securing the hub 16 to the shaft 12 comprises a fastener in the form of a stainless steel bolt 28 (FIG. 1) that extends through the hub 16, through a hole in the shaft such as 30. One insert, such as the insert 26 (FIG. 5) has a stainless steel nut 32 seated in a rectangular aperture. The bolt 28 extends through the rectangular aperture in the other insert 24, and through the shaft 12, and its male end is screwed into the female threaded nut 32 held in the rectangular aperture in the insert 26 and embedded within the hub 16. Other forms of securing means can be utilized, such as a bolt that does not penetrate the shaft 12 but instead holds the hub 16 tightly clamped around the shaft 12. In such a case the hub 16 should be dimensioned such that the opposing ends 16a and 16b do not contact each other, leaving the split 20 open when the hub 16 engages the shaft 12. This allows the hub to be tightened against the shaft 12 by drawing the opposing ends 16a and 16b toward each other. The securing means could also take the form of ancillary collars, clamps, brackets and/or sleeves for indirectly attaching or holding the hub 16 to the shaft 12 in releaseable fashion.

The impacting elements 22 (FIG. 2) are specially configured for classifying a stream of mixed recyclable materials. The leading edge 22a has a slightly curved shape. The outer end of each impacting element 22 is formed with an enlarged lobe 22b that takes longer to wear away. The spoke portion 22c of each impacting element 22 is dimensioned to allow the element 22 to flex rearwardly under load, allowing some of the leading edge 22a to contact the materials being classified.

The hinged disc 14 is preferably integrally molded as one unitary piece of elastomeric material in a mold (not illustrated) after the inserts cast Aluminum 24 and 26 have been positioned within the mold. The use of synthetic rubber, polyurethane or other similar durable elastomeric materials ensures that the impacting elements 22 will have high friction impacting surfaces to maximize their propelling. The use of elastomeric material also minimizes the likelihood that glass containers will be broken.

The hinged disc 14 is easier to dismount and mount than prior split discs because it is lighter, and only requires a single bolt to be removed and replaced. Also, the repairman does not need to hold up two separate disc pieces around the shaft, and try to insert bolts at the same time. A disc screen may incorporate several hundred discs, and the savings in terms of materials (expensive stainless steel bolts) and installation time can be significant. Moreover, the lighter weight of the hinged disc 14 than conventional split disks lessens the likelihood of damaged bearings, bent shafts and broken shafts.

Instead of using a segment of an elastomeric hub as the hinge, in an alternate embodiment the hinge may comprise a mechanical hinge assembly portion of the hub. Referring to FIGS. 6 and 7 the adjacent ends of a pair of cast Aluminum semi-circular inserts 34 and 36 are pivotally connected by a pin 38. These inserts are placed inside a mold and encased in suitable elastomeric material (not illustrated) and to form impacting elements (not illustrated) at the same time.

While I have described alternate embodiments of my invention, variations and modifications will occur to those skilled in the art. For example, both the shape and number of the plurality of outer impacting elements can widely varied to meet the needs of the materials being classified. For example, the disc could have a star configuration with rounded or sharp tips, or it could have a square configuration with rounded corners, or it could have an undulating outer contour as disclosed in U.S. Pat. No. 4,795,036 of Williams, or it could have a triangular contour with curved edges joining angled apices as disclosed in U.S. Pat. No. 5,799,801 of Clark et al. The bore 18 need not be circular, but could be rectangular, triangular, oval, etc. to accommodate shafts having matching outer cross-sections. The hinged disc could also be made entirely of metal for the purpose of crushing glass. Therefore, the protection afforded my invention should only be limited in accordance with the scope of the following claims.

What is claimed is:

1. A disc for releasable attachment to a shaft of a disc screen apparatus, comprising:
a generally ring-shaped hub having a bore and a split defining a pair of opposing ends and a hinge intermediate the opposing ends, the hinge permitting the opposing ends of the hub to be separated a predetermined distance sufficient to allow the shaft of a disc screen apparatus to pass between the opposing ends into the bore;
a plurality of outer impacting elements supported on the hub and configured for engaging materials to be classified and propelling the materials in a conveying direction when the hub is rotated; and
means for securing the hub to the shaft so that the shaft extends through the bore.

2. The disc of claim 1 wherein the hub has a single split, the hub is formed of an elastomeric material, and the hinge comprises a segment of the hub between the opposing ends having sufficient flexibility to allow the opposing ends to be manually separated the predetermined distance.

3. The disc of claim 2 and further comprising a pair of rigid inserts embedded in the hub on opposite sides of the hinge segment.

4. The disc of claim 3 wherein the inserts are made of metal.

5. The disc of claim 2 wherein the impacting elements are also made of the elastomeric material and are integrally formed with the hub.

6. The disc of claim 5 wherein the impacting elements comprise radially extending arms.

7. The disc of claim 1 wherein the means for securing the hub to the shaft comprises a fastener that extends through the hub and into the shaft.

8. The disc of claim 7 wherein the fastener extends through the shaft and has a male threaded end that screws into a female threaded nut embedded in the hub.

9. The disc of claim 1 wherein the opposing ends of the hub have complementary mating shapes to align the opposing ends when the hub is secured to the shaft.

10. The disc of claim 9 wherein the mating shapes have a saw-tooth configuration.

11. A disc for releasable attachment to a shaft of a disc screen apparatus, comprising:
a generally ring-shaped hub having a bore and a split defining a pair of opposing ends and a hinge intermediate the opposing ends, the hinge permitting the opposing ends of the hub to be separated a predetermined distance sufficient to allow the shaft of a disc screen apparatus to pass between the opposing ends into the bore; and
a plurality of outer impacting elements supported on the hub and configured for engaging materials to be classified and propelling the materials in a conveying direction when the hub is rotated.

12. The disc of claim 11 and further comprising means for securing the hub to the shaft so that the shaft extends through the bore.

13. The disc of claim 11 wherein the hub has a single split, the hub is formed of an elastomeric material, and the hinge comprises a segment of the hub between the opposing ends having sufficient flexibility to allow the opposing ends to be manually separated the predetermined distance.

14. The disc of claim 13 and further comprising a pair of rigid inserts embedded in the hub on opposite sides of the hinge segment.

15. The disc of claim 14 wherein the inserts are made of metal.

16. The disc of claim 13 wherein the impacting elements are also made of the elastomeric material and are integrally formed with the hub.

17. The disc of claim 11 wherein the impacting elements comprise radially extending arms.

18. The disc of claim 12 wherein the means for securing the hub to the shaft comprises a fastener that extends through the hub and into the shaft.

19. The disc of claim 18 wherein the fastener extends through the shaft and has a male threaded end that screws into a female threaded nut embedded in the hub.

20. A disc for releasable attachment to a shaft of a disc screen apparatus, comprising:
a generally ring-shaped hub formed of an elastomeric material, the hub having a bore and a split defining a pair of opposing ends and a hinge segment formed of the elastomeric material and located intermediate the opposing ends, the hinge segment having sufficient flexibility to permit the opposing ends of the hub to be manually separated a predetermined distance sufficient to allow the shaft of a disc screen apparatus to pass between the opposing ends into the bore;
a pair of metal inserts embedded in the hub on opposite sides of the hinge segment;
a plurality of outer impacting elements formed of the elastomeric material and extending radially from the hub, the impacting elements configured for engaging materials to be classified and propelling the materials in a conveying direction when the hub is rotated; and
a bolt assembly connected to at least one of the metal inserts for locking the hub to the shaft when the shaft extends through the bore.
